(19) United States
(12) Patent Application Publication
(10) Pub. No.: US 2026/0236884 A1
(43) Pub. Date: Aug. 13, 2026

(54) INVENTORY MONITORING SYSTEMS AND APPARATUSES

(71) Applicant: BISON Group Limited, Bradford (NZ)

(72) Inventors: Mark James Fahey, Saint Leonards (NZ); Gregory John Fahey, Belleknowes (NZ)

(21) Appl. No.: 19/534,242

(22) Filed: Feb. 9, 2026

(30) Foreign Application Priority Data
Feb. 12, 2025 (NZ) 818657

(51) Int. Cl. G06Q 10/087; H04W 4/35; H04W 4/38; H04W 4/80; H04W 84/18

(52) U.S. Cl. CPC G06Q 10/08772; H04W 4/35; H04W 4/38; H04W 4/80; H04W 84/18

(57) ABSTRACT

In one embodiment, a system comprises one or more wireless communication devices configured to receive wireless communication signals from wireless communication transmitters; a plurality of weight scales, each of the plurality of weight scales configured to at least partly support a supplies carrier, and each particular weight scale of the plurality of weight scales comprising a weight sensor configured to sense a weight supported by the particular weight scale; a wireless communication transmitter configured to wirelessly transmit signals to one or more of the wireless communication devices over a first distance; an input device configured to receive input from within a second distance, the second distance being less than the first distance; one or more processors in data communication with the wireless communication transmitter, the input device, and the weight sensor; and memory storing one or more sequences of instructions which, when executed, cause the one or more processors to configure, based on the input received by the input device, the wireless communication transmitter for communication of signals to one or more of the wireless communication devices; receive, from the weight sensor, data representative of the weight sensed by the weight sensor; and cause the wireless communication transmitter to transmit a signal to one or more of the wireless communication devices, the signal being based on the data representative of the weight sensed by the weight sensor, and the signal being transmitted in accordance with the input received by the input device.

### CROSS-REFERENCE TO RELATED APPLICATIONS

This application claims the benefit under 35 U.S.C. § 119(a) of New Zealand application 818657, filed 12 Feb. 2025, the entire contents of which are hereby incorporated by reference for all purposes as if fully set forth herein.

### FIELD

This invention relates to inventory monitoring systems and apparatuses.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Keeping track of inventory levels can be difficult and burdensome. For example, manual counting/measuring and reporting is time-consuming and prone to human error. Also, supplies are often spread out around large areas, which can require a lot of time and effort to visit and can make it difficult to keep track of the locations of supplies.

One application of inventory monitoring systems is in large-scale field operations, for example as conducted by military forces. These field operations can be in difficult and varied environments that can increase the difficulty of manual collection of inventory information. Military operations can also require high levels of security.

### BRIEF DESCRIPTION OF THE DRAWINGS

The accompanying drawings, which are incorporated in and constitute part of the specification, illustrate embodiments of the invention and, together with the general description of the invention given above and the detailed description of embodiments given below, serve to explain the principles of the invention.

FIG. 1 is a schematic illustration of an inventory monitoring system according to one example;

FIG. 2 is a schematic illustration of a weight scale and other devices according to one example; and

FIG. 3 is a schematic illustration of an inventory monitoring system deployed at a site according to one example.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are illustrated in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other, unless expressly specified otherwise. Additionally, devices that communicate with each other may do so directly or indirectly through one or more intermediaries, which can be logical or physical.

A description of an embodiment with several components in communication with one another does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order that is practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment, but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

According to one example there is provided an inventory monitoring system for monitoring quantities of supplies carried by a plurality of supplies carriers, the inventory monitoring system comprising:
a plurality of wireless communication transceivers configured to receive wireless communication signals from wireless communication transmitters and transmit to each other wireless communication signals based on the received wireless communication signals;
a computing device configured to receive signals from one or more of the wireless communication transceivers;
a plurality of weight scales, each of the plurality of weight scales configured to at least partly support a supplies carrier, and each of the plurality of weight scales comprising:
   a weight sensor configured to sense a weight supported by the weight scale;
   a wireless communication transmitter configured to wirelessly transmit signals to one or more of the wireless communication transceivers over a first distance;
   an input device configured to receive input from within a second distance, the second distance being less than the first distance; and
   control circuitry in data communication with the wireless communication transmitter, the input device, and the weight sensor, the control circuitry being configured to:
      configure, based on the input received by the input device, the wireless communication transmitter for communication of signals to one or more of the wireless communication transceivers;
      receive, from the weight sensor, data representative of the weight sensed by the weight sensor; and
      cause the wireless communication transmitter to transmit a signal to one or more of the wireless communication transceivers, the signal being based on the data representative of the weight sensed by the weight sensor, and the signal being transmitted in accordance with the input received by the input device.

The computing device may receive the signals directly or indirectly from the wireless communication transceiver(s).

According to a second example there is provided a weight scale configured to at least partly support a supplies carrier, the weight scale comprising:
a weight sensor configured to sense a weight supported by the weight scale;
a wireless communication transmitter configured to wirelessly transmit signals over a first distance according to a first communication protocol;
an input device configured to receive input from within a second distance, the second distance being less than the first distance; and
control circuitry in data communication with the wireless communication transmitter, the input device, and the weight sensor; and
a housing that houses the weight sensor, wireless communication transmitter, input device, and control circuitry;
wherein the control circuitry is configured to:
configure, based on the input received by the input device, the wireless communication transmitter for communication of signals according to the first communication protocol;
receive, from the weight sensor, data representative of the weight sensed by the weight sensor; and
cause the wireless communication transmitter to transmit a signal according to the first communication protocol, the signal being based on the data representative of the weight sensed by the weight sensor, and the signal being transmitted in accordance with the input received by the input device.

According to a third example there is provided weighing system comprising:
a plurality of weight scales, each of which is configured to partly support a supplies carrier, the plurality of weight scales being configured to together support the supplies carrier; and
a computing device;
wherein each of the weight scales comprises:
a weight sensor configured to sense a weight supported by the respective weight scale;
a wireless communication transmitter;
a data store configured to store timing data; and
control circuitry in data communication with the respective wireless communication transmitter and the respective weight sensor; wherein the control circuitry of each of the plurality of weight scales is configured to:
implement a clock that is synchronized with the clock(s) of the other weight scales(s), the clock producing timing data;
compare timing data of the respective clock to the timing data stored in the respective data store;
based on the comparison, record data representative of the weight sensed by the respective weight sensor at a first time, wherein the first time is the same for the plurality of weight scales; and
cause the respective wireless communication transmitter to transmit, to the computing device, a signal based on the recorded data; and wherein the computing device is configured to:
receive the signals transmitted by the wireless communication transmitters of the plurality of weight scales; and
determine, based on the received signals, a combined weight value representative of a weight of the supplies carrier at the first time.

The term “supplies” generally refers to anything whose level is to be monitored in the system. It can refer to commodities or goods, but the supplies do not need to have monetary value.

The inventory monitoring systems and apparatuses disclosed herein may allow for the collection of data, such as quantity, relating to supplies in an improved manner. The monitoring systems and apparatuses may utilize wireless, e.g. radio, communications to conveniently allow inventory data to be collected from various locations around a site, even when those locations are widely spread or difficult to access. The monitoring system may include weight scales that support supplies carriers while taking weight readings, allowing the quantity of supplies to be determined from the weight readings and in at least some cases from further knowledge of the tare weight of the supplies carriers and supplies'weight per unit item or volume. The weight scales may communicate data relating to weight measurements using a relatively long-range communication technology, while being configurable via a relatively short-range interface, which may provide inherent security by only allowing configuration by a person within close proximity of the weight scales. Multiple weight scales may cooperate to support a supplies carrier and measure its weight at a certain time by taking synchronized weight readings at that time. The system may use multiple wireless communications transceivers in a mesh network to relay signals from the weight scales to a computing device for collection. The wireless communications transceivers may be flexibly distributed around the site as needed, allowing for the area covered by the inventory monitoring system to be expanded or changed as needed. The wireless communications transceivers and weight scales may transmit over a range that is relatively limited so that the combined range of their signals conforms relatively closely to the area of the site. The systems and apparatuses may have various other advantages and applications as will be evident from the specification as a whole.

Other inventory monitoring systems may require people to manually inspect supplies, record information (such as quantity) about the supplies, and collate this to produce an inventory of supplies.

Other systems may include monitoring devices that use radio communications to report information about supplies to a monitoring device over a network. These systems may be insecure because the radio communications could be easily intercepted and it may be possible for an unauthorized party to reconfigure or otherwise hack the monitoring devices from a distant location, such as outside of the site being monitored. Such systems may also have a large electromagnetic “signature” or “footprint” due to the radio transmissions not being closely limited to the site and/or not being restricted in time. These systems may use long range transmitters to report data wirelessly to a central device or gateway in a single “hop”. To achieve this, the transmitters need a usable range at least equal to the distance to the central device or gateway. These transmissions may extend well beyond the site being monitored, which may be wasteful, produce a large electromagnetic signature, and increase the chances of the transmissions being detected from outside of the site.

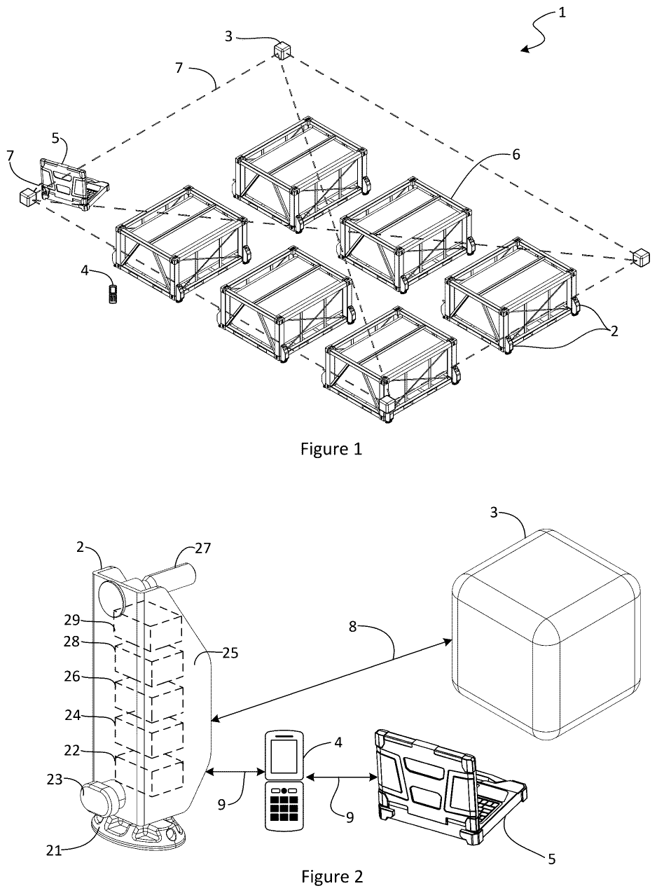

FIG. 1 illustrates an inventory monitoring system 1 according to an example embodiment.

In an embodiment, a computer system as described comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. The drawing figures illustrate only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of field collection of inventory information. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

The system 1 includes weight scales 2 that are configured to support supplies carriers 6, wireless communication transceivers 3, and a computing device 5. In some examples, the system can also include a mobile computing device 4.

The supplies carriers 6 can each be supported by one or more of the weight scales 2. In the example of FIG. 1, the supplies carriers 6 are each supported by four weight scales 2 with one weight scale at a different corner among four corners of the supplies carriers 6. In other examples, each of the supplies carriers 6 could be supported by one, two, three, five or more weight scales 2. The number and placement of weight scales 2 may be selected based on the properties (e.g. size, shape and/or weight) of the supplies carriers 6. The size, type of supporting structure that supports the supplies carrier 6, maximum rated load etc. of the weight scales 2 can be designed as appropriate for the supplies carriers 6 they are to support.

Various supplies carriers 6 may be used. The supplies carriers 6 can be cargo units. The supplies carriers 6 could be closed containers such as shipping containers, storage containers, barrels, tanks, bladders or the like. The supplies carriers 6 can be open containers or platforms such as crates, pallets or the like. The supplies carriers 6 could be vehicles or trailed containers such as tankers, trucks, trailers or the like. In typical applications, the supplies carriers 6 may be quadcons, tricons, 20′ ISO containers, Joint Module Intermodal Containers (JMIC), blivets, fuel tank trailers, or fuel or water bladders. The supplies carriers 6 can be any combination of the aforementioned types of supplies carriers.

Accessories or adapters may be provided to adapt the weight scales 2 to different types of supplies carriers 6. For example, beams could be used to span two weight scales 2 and support a supplies carrier 6, such as a pallet, on the beams. The weight scales 2 can be made relatively light weight to make them easier to move, especially by hand. The weight scales can be battery powered. Typically, they would be powered by rechargeable batteries that can be recharged in the field, e.g. by a portable power pack.

The weight scales 2 can be of a modular design allowing them to be configured for different maximum capacities and different levels of sensitivity or resolution. The weight scales 2 can be made resistant to shocks and environmental conditions expected to be encountered in the field.

The weight scales 2 can sense the weight of the supplies carriers 6 that they support and transmit weight data to the wireless transceivers 3. Each weight scale 2 can also transmit other data such as an identification code uniquely associated with itself (device ID), the time at which the weight data it transmitted was measured, and/or the energy level of its battery/batteries. In some examples, the weight scales 2 could also transmit data such as identification numbers of the supplies carriers 6 supported by the respective weight scales, tare weight of the supplies carriers 6 supported by the respective weight scales, type of supplies of the supplies carrier 6, and/or location of the weight scales 2 or supplies carriers 6.

Further details of the weight scales 2 are given later with reference to FIG. 2.

The wireless communications transceivers 3 can receive wireless communications from the weight scales 3. The wireless communications transceivers 3 can also send and receive wireless communications to and from each other. In particular, the wireless communications transceivers 3 can transmit wireless communication signals to each other, and optionally to other devices, that are based on the signals they receive from the weight scales 2. FIG. 1 shows exemplary transmission paths 7 between wireless communications transceivers 3 and each other, as well as between a wireless communications transceiver 3 and the computing device 5. In some examples, the wireless communication transceivers 3 act as repeaters, which retransmit the signals that they have received. Typically, the transceivers 3 would repeat the received signal without substantially altering it. The transceivers 3 can form a mesh network, which may increase reliability due to the multiple redundant paths that a signal may take through the network.

The wireless communications transceivers 3 could use any suitable wireless communication technology. Typically, the wireless communications transceivers would be radio transceivers. In some examples, the wireless communications transceivers 3 can operate in the UHF (ultra-high frequency) radio range, for example between 902 MHz and 928 MHz, for example at 915 MHz. The relatively long wavelengths of these frequencies may help signals to diffract around typical obstacles such as supplies carriers, vehicles, buildings and the like. The wireless communications transceivers 3 can use any suitable communication protocol. In some examples, the wireless communications transceivers 3 can use a Zigbee communication protocol.

The range of the wireless communication transceivers 3 is designed so that they can form paths for communications from the weight scales 2 to the computing device 5. The range of a wireless communications transceiver 3 can be at least as great as the expected distance between it and a neighboring wireless transceiver 3 to provide overlapping coverage and unbroken paths for communications. The range can be limited so that it does not extend too much further than is needed. This may enable the transmissions to remain relatively close to the site being monitored and/or minimize the electromagnetic signature/footprint of the monitoring system 1. In some examples, the range of the wireless communications transceivers 3 is less than about 1 km. In some examples, the range is about 100 m or less. The range of the wireless communication transceivers 3 may be controlled by controlling transmission power.

The wireless communications transceivers 3 can employ anti-jamming techniques such as frequency hopping and/or spread-spectrum transmission, for example frequency-hopping spread-spectrum (FHSS), direct-sequence spread-spectrum (DSSS), or adaptive frequency agility.

Communications to and from the wireless communications transceivers 3 can be encrypted.

The wireless communications transceivers 3 can transmit signals in bursts rather than continuously. This may reduce power consumption and/or electromagnetic signature/footprint.

The wireless communications transceivers 3 can be portable. This may allow them to be easily added to or removed from the site or moved around for better performance. The wireless communications transceivers 3 can be battery powered. It will be appreciated that many of the features discussed above may help prolong battery life. These include the burst transmission and the limited range (and hence limited transmission power) of the transmissions. The wireless communications transceivers 3 could transmit information about their own battery levels to the computing device 5. In these cases, the signals from the wireless communications transceivers 3 can include a device ID of a transceiver 3 associated with its own battery energy level.

The wireless communication transceivers 3 can have Global Positioning System (GPS) units or other location-determining means to determine their own locations. Alternatively or additionally, a user could input the location of a wireless communications transceiver 3 to the wireless communication transceiver 3 or report it to the computing device 5 when placing the transceiver 3 in the field.

The wireless communications transceivers 3 can include data stores, allowing them to store data received from other devices in the system 1. For example, the wireless communications transceivers 3 may store the weight, timing and/or device ID data from the weight scales. The wireless communications transceivers 3 may also store data about some or all of the supplies, supplies carriers 6, and/or weight scales 2. This data can include tare weight(s) of the supplies carrier(s) 6, type of supplies carried by the supplies carrier(s) 6, weight of supplies per unit, and identifier(s) of weight scale(s) 2 and/or supplies carrier(s) 6. This may provide the system 1 with resilience in case of loss of data. Multiple partial or complete copies of the data used to monitor the inventory can be stored in the wireless communications transceivers 3. These may be used as backups in case of loss of data elsewhere in the system 1, for example in the computing device 5. This may also allow calculations, such as determination of a quantity of supplies in one or more supplies carrier(s) 6 to be performed on the wireless communications transceivers 3.

In some examples, there may be only one wireless communications device instead of the plural wireless communications transceivers 3. In such examples, the one device can receive wireless communications from each weight scale 2. These wireless communications can be as described in connection with the wireless communications transceivers 3. In some examples, instead of one or more of the wireless communications transceivers 3, the system could include one or more devices that do not necessarily transmit information wirelessly. These devices could receive information wirelessly but transmit information over a wired connection. For example, these wireless communications devices could have a wired connection to a local network or a wide area network such as the internet. The broader term “wireless communications devices” includes devices that receive and transmit information wirelessly, such as the wireless communications transceivers 3, and devices that receive information wirelessly but do not transmit information wirelessly.

Although only one computing device 5 is depicted, in some examples there may be more than one such computing device 5. The computing device 5 can include one or more processors. The computing device 5 can include one or more data storage devices such as volatile and/or non-volatile storage devices. The computing device 5 can include a combination of volatile digital electronic memory (e.g. random-access memory) and long-term storage (e.g. non-volatile, non-transitory memory such as a magnetic hard disk or solid-state storage device). The computing device 5 can have one or more communication interfaces including wired and/or wireless connections. For example, the computing device 5 can have one or more interfaces suitable for universal serial bus (USB), Wi-Fi, Bluetooth, Near-Field Communication (NFC), Ultra-Wideband (UWB), Ethernet, Transmission Control Protocol/Internet Protocol (TCP/IP), Human-Machine Interface (HMI) connections, protocols, and communications.

The computing device 5 can be a special-purpose computing device constructed specifically for use in the system 1. Alternatively, the computing device 5 can be a general-purpose computing device such as a laptop computer, tablet computer, smartphone, microcomputer, microcontroller, laptop computer, other mobile computing device, desktop computer, or workstation. In one embodiment, the computing device 5 is a special-purpose computing device dedicated to operation in the system 1. The computing device 5 can be based on a single-board computer, for example a Raspberry Pi. The computing device 5 can be provided in a suitable housing, which can be ruggedized or otherwise made resistant to expected conditions in the field and during transport.

The computing device 5 can collect any of the data transmitted by the weight scales 2 via the network of transceivers 3. The computing device 5 can receive wireless communications directly from one or more of the wireless communication transceivers 3 using any suitable wireless communication interface. Alternatively or additionally, the computing device 5 can receive the data over a wired connection. In the example of FIG. 1, only a wireless connection (indicated by wireless signal 7) between the computing device 5 and one of the wireless communication transceivers 3 is shown.

The computing device 5 can run an application configuring it for operation in the system 1. The application can, for example, be stored as one or more sequences of instructions in any suitable non-transitory storage medium. This could be a storage device of the computing device 5 or it could be a separate storage device readable by the computing device 5, such as a compact disk (CD), digital versatile disk (DVD), floppy disk, external hard drive or flash drive etc.

The computing device 5 can collect the data from the weight scales 2 to monitor the inventory across the whole site. The inventory can include various different types of supplies of various different supplies carriers. The information received by the computing device 5 can be from various different weight scales 2 that support various different supplies carriers 6 that carry different kinds of supplies and have different tare weights. The information can also relate to weight measurements taken at different times and from different locations.

The computing device 5 can be configured to determine the gross weight of a supplies carrier 6 by combining the weight measured by each weight scale 2 associated with that supplies carrier 6 or, in the case of a supplies carrier 6 supported by only one weight scale 2, directly from the weight measured by that weight scale 2. The computing device 5 can determine the weight of the supplies of the supplies carrier 6 (i.e. the net weight) by subtracting tare weight of the supplies carrier 6 from the gross weight. The computing device 5 can convert the weight measurement to another quantity by dividing the net weight by the known weight of a particular—e.g. salient or standard—unit of the supplies. For example, supplies that come in discrete units such as ammunition boxes can be of a known weight per box. Dividing the net weight of the boxes by the weight of each box will give the number of boxes on the supplies carrier 6. Supplies that come as bulk or continuous quantities such as liquid fuel can have a known weight per unit volume, e.g. gallon or liter. Dividing the net weight by the weight per unit volume will give the number of gallons or liters of liquid fuel. The computing device 5 could use the received information to determine the total quantity of each type of supply (e.g. gallons of fuel, boxes of ammunition), the quantity for each supplies carrier 6 or for certain subsets of supplies carriers 6, and/or the quantity of each supply within a geographical area (using the location information of the weight scales and/or supplies carriers). The computing device 5 can receive and make available battery energy level data of weight scales 2 and/or wireless communication transceivers 3. Using the information about the times that measurements were taken, the computing device 5 could also determine inventory information for different times. The computing device 5 could calculate the quantities and other inventory information at the most recent time that it has complete data for, but it could also store a record of the weight measurements and/or determined inventory information (quantities etc.) from earlier times and make these available to a user or other computing device. The computing device 5 could also use the data from different times to produce time-series information like patterns in depletion of the supplies over time, rates of change of quantities, rates of energy consumption of device batteries etc.

In some examples, the computing device 5 could be an existing computing device of the site operator. The computing device 5 could be part of the site operator's computer network. In some examples, the site operator could also use their own mobile computing device(s) as one or more of the mobile computing device(s) 4. In some scenarios, the weight scales 2 and wireless communications transceiver(s) 3 (or other wireless communication device(s)) could be provided to the site operator for use with their existing computing device(s) 5 and/or mobile computing device(s) 4. In some examples, one or more computing applications could also be provided to the site operator to configure one or more of the site operator's computing devices for use in the system.

In some examples, the calculations of gross weight, net weight and/or quantity of supplies discussed in the preceding paragraph could be performed by the weight scales 2 and/or the transceivers 3. This can be in addition to, or as an alternative to, the computing device 5 performing the calculations. For example, the weight scales 2 associated with a supplies carrier could communicate weight sensor data to each other so that at least one of the weight scales 2 has the weight sensor data of all weight scales 2 that support the supplies carrier 6. In situations where only one weight scale supports a supplies carrier, this communication step is not needed. The gross weight, net weight and/or quantity of the supplies can then be calculated by the weight scale(s) 2. The weight scale(s) 2 can then transmit the results of the calculations to the transceivers 3 for storage and/or retransmission to the computing device 5. The weight scales 2 can gather the weight data, perform the calculations and/or transmit the results of the calculations when periodically/intermittently waking up. In another example, one or more of the transceivers 3 can calculate the gross weight, net weight and/or quantity of the supplies carried by one or more of the supplies carriers 6. In these examples, the transceiver(s) can then store the results of the calculations and/or transmit them to the computing device 5. In examples in which weight scales 2 or transceivers 3 perform the calculations, the information needed for the calculations can be stored on or retrieved by the weight scales 2 and/or transceivers 3. For example, the tare weight of a supplies carrier and information about the supplies such as weight per unit can be communicated to the weight scales by a user of a mobile computing device 4 and can be communicated from the weight scales 2 to the transceivers 3 via wireless transmissions 7. In examples in which weight and/or quantity calculations are performed by weight scales 2 and/or transceivers 3, these may not need to be performed by the computing device 5.

The computing device 5 is shown as a standalone device in FIG. 1, but in some examples it could work in cooperation with another computing device. For example, the computing device 5 might have no or a rudimentary user interface/HMI (human-machine interface) but it could be connected to another computing device with a more comprehensive user interface, for example including a monitor and input devices like a keyboard and mouse, trackpad or touchscreen (which could double as the monitor). In some examples, the computing device 5 could be connected to a laptop computer or tablet. The connected device, e.g. laptop computer, could provide a convenient user interface for a user to review and make use of the inventory information. The computing device 5 or other device connected to it could run inventory management or logistics software and use the inventory information determined by the computing device as inputs to that software. In some examples, the computing device 5 or another device connected to it could make the data available over an external network. The information could be provided to a remote server such as a cloud server. In some examples, it might be appropriate to only make a subset of the inventory information available to a remote device for security reasons. In examples in which the inventory information is made available over an external network, e.g. via a cloud server, several systems 1 and different sites could be monitored using a remote computer that accesses the inventory information from the different sites over the external network.

The computing device 5, weight scales 2, and/or the wireless communications transceivers 3 can have input devices for receiving information. In the example of FIG. 1, a mobile computing device 4 can be used to provide inputs to one or more of the computing device 5, weight scales 2, wireless communications transceivers 3. Although only one mobile computing device 4 is depicted, in some examples there may be more than one such mobile computing device 4. The mobile computing device 4 can communicate with the weight scales 2 wirelessly via a wireless communications interface of the weight scales 2 which acts as an input device of the weight scales 2. The mobile computing device 4 could communicate with respective wireless communication interfaces of the computing device 5 and/or wireless communication transceivers 3. The wireless communications can use a relatively short-range technology. In particular, the communications to the interfaces of the weight scales 2, computing device 5 and/or wireless communication transceivers 3 can use technology that has a shorter range than the range of the transmissions 7 from the weight scales 2 to the wireless communication transceivers 3 and between wireless communication transceivers 3. In some examples, the weight scales receive inputs using Bluetooth communications, for example BLE class III. Alternatively or additionally, the weight scales 2 could include an HMI such as a keypad or touchscreen for receiving inputs. Alternatively or additionally, the weights scales 2 could include one or more ports—such as USB ports—for receiving input over a wired connection. It will be appreciated that HMIs and wired connections also require close proximity to the weight scales 2.

A mobile computing device 4 could be a mobile phone or a tablet computer, for example. Typically it would be a mobile phone running an application designed for use in the inventory management system 1. The mobile application could provide an interface for gathering data such as device IDs of the weight scales, IDs of the supplies carriers, type of supplies, tare weights of the supplies carrier, locations of the weight scales and/or supplies carriers, photographs of the supplies and/or supplies carrier, and/or user comments.

Regarding location, the mobile computing device 4 could record its own location when it is placed at or near the weight scales or supplies carrier. The mobile computing device's 4 location could be determined using the mobile computing device's 4 own GPS unit. Alternatively or additionally, the location of a weight scale 2 could be determined from the timing of arrival of its signals at multiple wireless communications transceivers 3. This may be done using the technique known as Time Difference of Arrival (TDoA). The position of the weight scale 2 relative to the wireless communications transceivers 3 would be determined from the timing information. The absolute location of the weight scale 2 can then be determined from its determined relative position and known locations of the wireless communications transceivers 3. Alternatively or additionally, the weight scales 2 could include GPS units to determine their own position directly.

FIG. 2 shows a weight scale 2, wireless communication transceiver 3, mobile computing device 4, and computing device 5 of the system 1 and illustrates communication links between them.

The weight scale 2 includes a weight sensor 22, an input device 24, a wireless communication transmitter 26, and control circuitry 28. The weight scale in this example also has a storage device 29 for storing data and instructions. The weight scale in this example also includes a base 21, support structure 23, housing 25 and handle 27. In the example shown, the weight scale 2 is configured for supporting a container and the support structure 23 is a protrusion that is inserted into a hole or recess in the side of the container. It will be appreciated that the support structure 23 and other parts of the weight scale can be configured differently for different types of supplies carriers.

In the example of FIG. 2, the input device 24 is a wireless communication interface. The wireless communication interface receives data from the mobile computing device 4, which in this example is a mobile phone. The input device 24 is configured for short range communications with the mobile computing device over a distance 9. The distance 9 can be less than about 10 m, between about 1 m and about 5 m, or about 2 m. The input device 24 can be a Bluetooth module that communicates with a Bluetooth module of the mobile computing device 4, for example using a BLE Class III protocol. The communications between the input device 24 and the mobile computing device 4 can use a higher frequency than communications from the wireless communication transmitter 26 to the wireless communication transceiver 3. In some examples, the communications are at 2.4 GHz.

The inputs to the input device 24 can be used to configure the weight scale 2 for communications with the wireless communications transceiver 3 (and, more generally, with any wireless communication transceiver 3 in the network of transceivers). This may be known as provisioning. This can involve the mobile computing device 4 transmitting to the input device 24 a network address to be used by the weight scale when transmitting signals from the transmitter 26, a transmission band to use for communications, and/or information indicating which time slots can be used for transmission. Generally, any information necessary to provision the transmitter for communications according to the protocol used by the wireless communications transceivers may be provided via the input device 24. In some cases, the transmission time slots for weight scales 2 throughout the network may be scheduled to avoid network congestion and minimize emissions. Communications between the weight scales 2 (using transmitter 26) and the wireless communication transceivers 3 can be one-way transmission, with the weight scales 2 not receiving transmissions from the transceivers 3. This means that the weight scales 2 do not receive any long-range communications, which may increase security as they can only be accessed from close proximity.

The mobile computing device 4 can also set the times at which the weight scales 2 “wake up” and record weight measurements, re-zero the weight scales before the supplies carrier 6 is placed on them, and/or recalibrate the weight scales 2 as needed. The mobile communication device 4 can also gather data such as the identification code from the weight scales 2, establish the association between the weight scales' ID, cargo unit serial number and type of supplies, view the current reading of the weight scales 2, record the tare weight of the supplies carrier 6, and/or capture the location of the weight scales 2 or supplies carrier 6, and convey this information to the computing device 5. The mobile computing device 4 can communicate with the computing device 5 using the same means as with the input device 24 of the weight scales 2. These communications can also be short range communications over the distance 9.

Once the weight scale is configured for communication with the wireless transceivers 3, it can begin communicating weight data to the computing device 5 via the network of wireless communication transceivers 3. The communications with the transceivers 3 are relatively long-range communications over a distance 8. Because the computing device 5 has been provided with the information regarding the weight scale 2 (its ID, the ID and tare weight of the supplies carrier than it supports, the type of supplies etc.) this information can be used by the computing device 5 to determine the quantity of the particular supplies associated with the weight scale 2, along with location of the weight scale, type of supplies of its associated supplies carrier 6 etc. Any of these calculations could alternatively or additionally be performed by other devices in the system 1 including one or more of the weight scales 2, one or more of the wireless communications transceivers (3) (or other wireless communications devices), and/or one or more of the mobile computing devices 4.

As mentioned previously and shown in FIG. 1, often a supplies carrier 6 such as a container will be supported by multiple weight scales 2. In this case, the weight of the supported carrier 6 is determined from the combined weights measured by the scales 6. This combination may be a simple sum of the magnitudes of the weights. Alternatively, this may be a vector sum, a weighted sum, or some other combination as appropriate. To ensure that the calculated total weight is accurate, weight scales 2 that support the same supplies carrier 6 can take their weight readings simultaneously or at least within a time window of each other. The time window may be a programmed, configured or otherwise predetermined time window. The time window may be a small time window. The weight scales 2 can each include a storage device 29 that stores information about when the scales 2 should take weight measurements. The control circuitry 28 of each weight scale 2 implements a clock. The clocks and timing data can be set to cause the weight scales to take weight measurements at the same times or within a time window. The clocks of all of the weight scales 2 that support the same supplies carrier 6 can be synchronized with each other. Typically, all of the weight scales 2 in the system 1 may be synchronized with each other. Weight scales 2 that support the same supplies carrier 6 can then be configured to take weight readings at the same time by providing them with the same “wake up” timing data to store in the storage device 29. The weight scales can wake up at regular intervals, i.e. periodically. Alternatively, they could wake up intermittently.

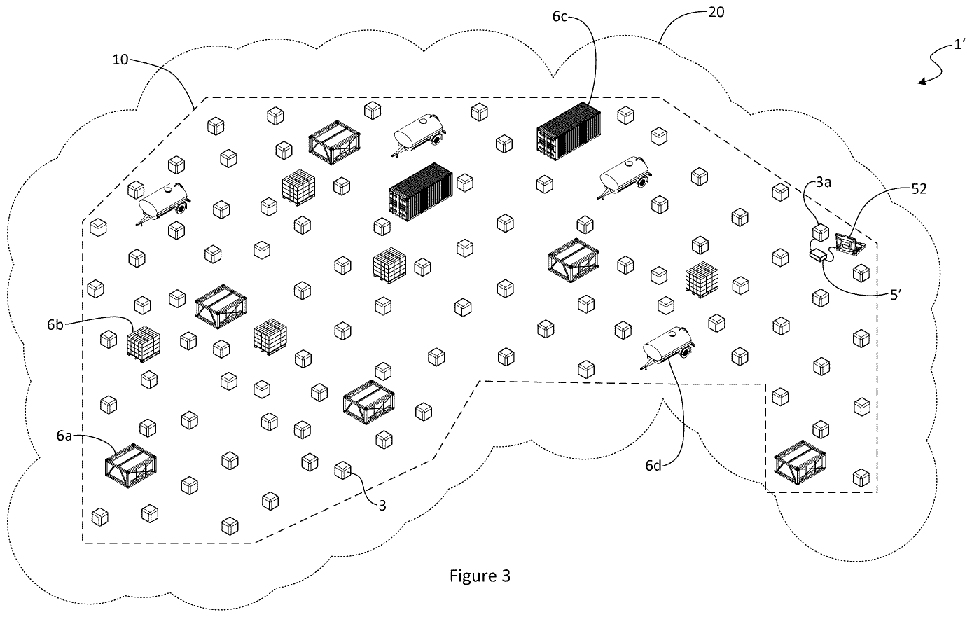

FIG. 3 shows an exemplary form of the system 1′ implemented at a site 10 to be monitored. As can be seen, the site 10 is somewhat irregular in shape as real sites may be in practice. Sufficient wireless communications transceivers 3 are placed around the site to provide unbroken transmission paths between the weight scales 2 and the computing device 5′ and receive transmissions from weight scales 2 associated with any of the supplies carriers 6. The combined coverage area of the wireless communications transceivers 3 is indicated by the line 20. As can be seen, providing several transceivers 3, each with a relatively limited range, around the site 10 may allow the combined coverage area or “footprint” to conform quite closely to the area of the site 10. Of course, the line 20 is illustrative only and it will be understood that the actual coverage will be more complicated, may vary with conditions and may gradually fade with distance rather than have a sharp boundary.

In the example of FIG. 3, various different types of supplies carriers are shown, including quadcon 6a, pallets 6b, 20′ ISO containers 6c, and fuel tank containers 6d.

In the example of FIG. 3, the computing device 5′ is connected to one of the wireless communications transceivers 3a by a wired connection. In such an example, the transceiver 3a could be replaced by or function as a device that receives wireless communications but need not transmit wireless signals, although typically it would be a wireless communication transceiver. In alternative examples, the computing device 5′ could have its own wireless communications receiver configured for receiving wireless communications directly from the network of transceivers 3.

In the example of FIG. 3, the computing device 5′ is connected to another computing device 52, which can, for example, be a laptop computer. This may run an inventory monitoring application and may be used by a user to collect and view inventory information from the computing device 5′ as discussed earlier. As also previously discussed, the computing device 5′ could be connected to an external network, either directly or via another device such as the computing device 52.

Unlike past approaches, the systems, apparatuses, and methods of the disclosure provide, for example, faster and more convenient inventory data collection techniques. The inventory data collection techniques can avoid the need for manual data collection. The inventory data collection techniques can use multiple wireless communication devices in a mesh network for improved redundancy and robustness of signal paths used for collecting the inventory data. The multiple communication device can be placed around an operations site so that they can receive wireless communications over a coverage area that closely conforms to the operations site. The inventory data collection techniques can have increased security. The close conformity of the wireless coverage area also increases security by reducing wireless signal leakage or “footprint”. Security is also increased by the use of short-range interfaces to provision the weight scales for wireless communication in the system. Accuracy of weights recorded by the weight scales is improved by synchronization of weight measurements taken by multiple weight scales that together support a supplies carrier. Periodic or intermittent waking up (e.g. to take measurements or transmit data) of devices reduces overall power consumption and wireless emissions.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A system comprising:
one or more wireless communication devices configured to receive wireless communication signals from wireless communication transmitters;
a plurality of weight scales, each of the plurality of weight scales configured to at least partly support a supplies carrier, and each particular weight scale of the plurality of weight scales comprising:
a weight sensor configured to sense a weight supported by the particular weight scale;
a wireless communication transmitter configured to wirelessly transmit signals to one or more of the wireless communication devices over a first distance;
an input device configured to receive input from within a second distance, the second distance being less than the first distance;
one or more processors in data communication with the wireless communication transmitter, the input device, and the weight sensor; and
memory storing one or more sequences of instructions which, when executed, cause the one or more processors to:
configure, based on the input received by the input device, the wireless communication transmitter for communication of signals to one or more of the wireless communication devices;
receive, from the weight sensor, data representative of the weight sensed by the weight sensor; and
cause the wireless communication transmitter to transmit a signal to one or more of the wireless communication devices, the signal being based on the data representative of the weight sensed by the weight sensor, and the signal being transmitted in accordance with the input received by the input device.

2. The system of claim 1, wherein the input device of the particular weight scale is a wireless communication interface.

3. The system of claim 2, wherein the wireless communication transmitter of the particular weight scale and the wireless communication interface use different communication technologies.

4. The system of claim 3, wherein the wireless communication interface is configured to communicate using signals having shorter wavelengths than signals used by the wireless communication transmitter.

5. The system of claim 1, wherein the wireless communication transmitter is configured for one-way communication of signals to one or more of the wireless communication devices.

6. The system of claim 1 further comprising a mobile computing application configured to cause a mobile computing device to wirelessly communicate with plural input devices of the plurality of weight scales, receive inputs from a user via the application, and provide the inputs to the plural input devices of the plurality of weight scales to configure the wireless transmitters of the weight scales.

7. The system of claim 6, wherein the mobile computing application is configured to cause the mobile computing device to wirelessly communicate with one or more of the wireless communication devices to configure one or more of the wireless communication devices for communications in the system.

8. The system of claim 1, wherein the one or more wireless communications devices comprises a plurality of wireless communications transceivers configured to transmit to each other wireless communication signals based on the received wireless communication signals.

9. The system of claim 8, wherein the wireless transceivers are configured to form a mesh network.

10. The system of claim 1, wherein one or more of the wireless communications devices are configured to:
store data representative of one or more of: the weight sensed by the weight sensor of one or more of the plurality of weight scales, a net weight of supplies carried by the supplies carrier supported by one or more of the of the plurality of weight scales, and a quantity of the supplies carried by the supplies carrier supported by one or more of the plurality of weight scales; and
provide, to a separate computing device, access to the stored data.

11. The system of claim 1, wherein the system is configured to determine quantities of supplies carried by the supplies carrier supported by one or more of the plurality of weight scales based on the data representative of weight sensed by the weight sensor of the one or more of the plurality of weight scales.

12. The system of claim 11, wherein a separate computing device is configured to determine quantities of supplies carried by the supplies carrier supported by one or more of the plurality of weight scales based on the data representative of weight sensed by the weight sensor of the one or more of the plurality of weight scales.

13. The system of claim 11, wherein one or more of:
the plurality of weight scales; and
the one or more wireless communications devices;
are configured to determine quantities of supplies carried by the supplies carrier based on the data representative of weight sensed by the weight sensor of one or more of the plurality of weight scales.

14. The system of claim 11, wherein the quantities are determined based on weight measured by the weight sensor, a tare weight of the supplies carrier, and a known weight of the supplies per unit.

15. The system of claim 10, wherein the separate computing device is configured to determine a total quantity of a type of good carried by a plurality of supplies carriers.

16. A weight scale configured to at least partly support a supplies carrier, the weight scale comprising:
a weight sensor configured to sense a weight supported by the weight scale;
a wireless communication transmitter configured to wirelessly transmit signals over a first distance according to a first communication protocol;
an input device configured to receive input from within a second distance, the second distance being less than the first distance;
one or more processors in data communication with the wireless communication transmitter, the input device, and the weight sensor;
memory storing one or more sequences of instructions; and
a housing that houses the weight sensor, wireless communication transmitter, input device, one or more processors, and memory;
wherein the one or more sequences of instructions stored on the memory are configured to cause the one or more processors to:
configure, based on the input received by the input device, the wireless communication transmitter for communication of signals according to the first communication protocol;
receive, from the weight sensor, data representative of the weight sensed by the weight sensor; and
cause the wireless communication transmitter to transmit a signal according to the first communication protocol, the signal being based on the data representative of the weight sensed by the weight sensor, and the signal being transmitted in accordance with the input received by the input device.

17. The weight scale of claim 16, wherein the input device of the weight scale is a wireless communication interface.

18. The weight scale of claim 17, wherein the wireless communication transmitter and the wireless communication interface are configured to use different communication technologies.

19. The weight scale of claim 18, wherein the wireless communication interface is configured to communicate using signals having shorter wavelengths than signals used by the wireless communication transmitter.

20. The weight scale of claim 16, wherein the wireless communication transmitter is configured for one-way communication of signals.

21. The weight scale of claim 16, wherein the one or more sequences of instructions stored on the memory include one or more of:
instructions configured to cause the one or more processors to record data indicative of weight sensed by the weight sensor periodically or intermittently; and
instructions configured to cause the wireless communication transmitter to transmit signals periodically or intermittently.

22. The weight scale of claim 16 comprising a carry handle.

23. A weighing system comprising:
a plurality of weight scales, each of which is configured to partly support a supplies carrier, the plurality of weight scales being configured to together support the supplies carrier; and
a computing device;
wherein each particular weight scale of the plurality of weight scales comprises:
a weight sensor configured to sense a weight supported by that particular weight scale;
a wireless communication transmitter;
one or more processors in data communication with the wireless communication transmitter and the weight sensor; and
memory storing timing data and one or more sequences of instructions for causing the one or more processors of the particular weight scale to:
implement a first clock that is synchronized with one or more second clocks of one or more second weight scales of the plurality of weight scales, the first clock producing timing data;
compare the timing data of the first clock to the timing data stored in the memory of the particular weight scale;
based on the comparison, record data representative of the weight sensed by the weight sensor of the particular weight scale within a first time window, wherein the first time window is the same for all weights scales of the plurality of weight scales; and
cause the wireless communication transmitter of the particular weight scale to transmit a signal based on the recorded data; and
wherein the computing device is configured to:
receive the signals transmitted by the wireless communication transmitters of the plurality of weight scales; and
determine, based on the received signals, a combined weight value representative of a weight of the supplies carrier within the first time window.

24. The weighing system of claim 23, wherein the one or more sequences of instructions stored on the memory of each particular weight scale of the plurality of weight scales is configured to cause the one or more processors of the particular weight scale to:
compare timing data of the first clock of the particular weight scale to timing data stored in the memory of the particular weight scale; and
based on the comparison, transmit the signal within a second time window, wherein the second time window is the same for all weight scales of the plurality of weight scales.

25. The weighing system of claim 23, wherein:
each particular weight scale among the plurality of weight scales comprises a wireless communication interface for receiving inputs from the computing device or another computing device; and
the one or more sequences of instructions stored in the memory are configured to cause the one or more processors of the particular weight scale to store the timing data in the memory based on the inputs received via the wireless communication interface.

26. The weighing system of claim 23, wherein the signal transmitted by the wireless communication transmitter includes data indicative of the first time window.
